(19) United States
(12) Patent Application Publication
(10) Pub. No.: US 2008/0126618 A1
(43) Pub. Date: May 29, 2008

(54) System, method and device of a scheduling interrupt controller

(76) Inventor: Ilan Pardo, Ramat Hasharon (IL)

Correspondence Address: PEARL COHEN ZEDEK LATZER, LLP, 1500 BROADWAY, 12TH FLOOR, NEW YORK, NY, 10036, US

(21) Appl. No.: 11/475,990

(22) Filed: Jun. 28, 2006

(51) Int. Cl. G06F 13/24

(52) U.S. Cl. 710/48

(57) ABSTRACT

Embodiments of the invention provide a device having a scheduling interrupt controller, as well as systems and methods thereof. For example, a scheduling interrupt controller and method thereof is able to prioritize and schedule interrupt requests according to dynamic system needs. The interrupt controller may schedule a plurality of interrupt requests from a plurality of interrupt sources having respective interrupt latency tolerances, based on one or more timing parameters of the requests, wherein at least one of the timing parameters is responsive to an allowable timespan for processing the requests to avoid latency error. Other features are described and claimed.

### BACKGROUND OF THE INVENTION

Interrupt latency is the time between the generation of an interrupt by a device and the servicing of the device which generated the interrupt. Interrupt latency may be effected by interrupt controllers, interrupt masking, and the operating system's interrupt handling methods.

Many computer systems require low interrupt latencies, especially embedded systems that need to control machinery in real-time. For example, in a system that uses a real-time operating system (RTOS), the RTOS must guarantee that interrupt latency will not exceed a predefined maximum.

In existing interrupt controllers, priority of requests is either handled according to a fixed scheme, or it is differed to the operating system's interrupt service routine (ISR). Some interrupt controllers allow configuring the priorities under software control; others define fixed priorities such that connection of the source device to a specific interrupt controller input defines its priority. A common characteristic of all such interrupt controllers is that strict priority is used and the priority, once defined, is static.

### BRIEF DESCRIPTION OF THE DRAWINGS

The subject matter regarded as die invention is particularly pointed out and distinctly claimed in the concluding portion of the specification. Embodiments of the invention, however, both as to organization and method of operation, together with features and advantages thereof, may best be understood by reference to the following detailed description when read with the accompanied drawings in which:

FIG. 1 is a schematic diagram of a computing system incorporating an interrupt controller in accordance with some demonstrative embodiments of the invention;

FIG. 2 is a schematic timing diagram helpful in understanding functionality of an interrupt controller in accordance with some demonstrative embodiments of the invention;

FIG. 3 is a schematic diagram of bit and data structures of an interrupt controller in accordance with some demonstrative embodiments of the invention;

FIG. 4 is a schematic flowchart of a method of scheduling interrupt requests in accordance with some demonstrative embodiments of the invention;

FIG. 5 is a schematic flowchart diagram of a method of reporting interrupt requests in accordance with some demonstrative embodiments of the invention; and

FIG. 6 is a schematic diagram of a wireless communication system using an interrupt controller in accordance with some demonstrative embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of embodiments of the invention as described herein.

It should be appreciated that according to some embodiments of the present invention, the method described below, may be implemented in machine-executable instructions. These instructions may be used to cause a general-purpose or special-purpose processor that is programmed with the instructions to perform the operations described. Alternatively, the operations may be performed by specific hardware that may contain hardwired logic for performing the operations, or by any combination of programmed computer components and custom hardware components.

Although the scope of the present invention is not limited in this respect, the system and method disclosed herein may be implemented in many wireless, handheld and portable communication devices. By way of example, wireless, handheld and portable communication devices may include wireless and cellular telephones, smart telephones, personal digital assistants (PDAs), web-tablets and any device that may provide wireless access to a network, such as an intranet or the internet. It should be understood that the present invention may be used in a variety of applications. For example, the circuits and techniques disclosed herein may be used in many apparatuses such as personal computers, stations of a radio system, wireless communication system, digital communication system, satellite communication system, and the like, although embodiments of the invention are not limited in this respect.

Some embodiments of the invention may be used in conjunction with many apparatuses and systems, for example, a transmitter, a receiver, a transceiver, a transmitter-receiver, a wireless communication station, a wireless communication device, a wireless access point (AP), a modem, a wireless modem, a personal computer, a desktop computer, a mobile computer, a laptop computer, a notebook computer, a personal digital assistant (PDA) device, a tablet computer, a server computer, a network, a wireless network, a local area network (LAN), a wireless LAN (WLAN), devices and/or networks operating in accordance with existing IEEE 802.11 (Institute of Electrical and Electronics Engineers “IEEE-Std 802.11, 1999 Edition (ISO/IEC 8802-11: 1999)”), 802.11a, 802.11b, 802.11e, 802.11 g, 802.11h, 802.11i, 802.11n, 802.16 standards and/or future versions of the above standards, a personal area network (PAN), a wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a personal communication systems (PCS) device, a PDA device which incorporates a wireless communication device, a multiple input multiple output (MIMO) transceiver or device, a single input multiple output (SIMO) transceiver or device, a multiple input single output (MISO) transceiver or device, a multi receiver chain (MRC) transceiver or device, a transceiver or device having “smart antenna” technology or multiple antenna technology, or the like.

Some embodiments of the invention may be used in conjunction with one or more types of wireless communication signals and/or systems, for example, radio frequency (RF), infra red (IR), spread spectrum signals, frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, multi-carrier modulation (MDM), discrete multi-tone (DMT), Bluetooth®, ZigBee™), or the like. Embodiments of the invention may be used in various other apparatuses, devices, systems and/or networks.

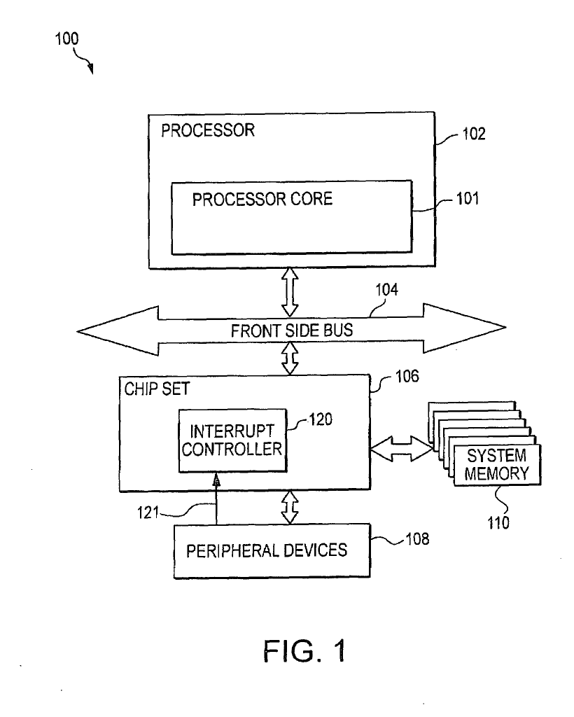

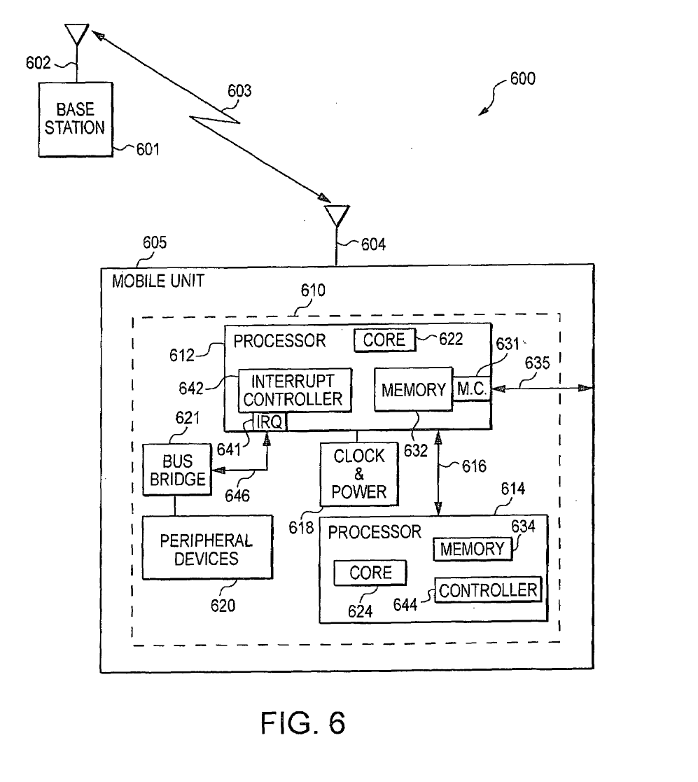

Reference is made to FIG. 1, which schematically illustrates a computing system 100 in which a scheduling interrupt controller in accordance with some demonstrative embodiments of the invention may be used. Although embodiments of the invention are not limited in this respect, system 100 may be, for example, a general computing system, an embedded computing system, or any other computing system that includes at least a general-purpose or special purpose processor, e.g., processor 102, and an interrupt controller 120 able to schedule interrupt requests for the processor, as described in detail below. Computing system 100 may include or may be, for example, a computing platform, a processing platform, a personal computer, a desktop computer, a mobile computer, a laptop computer, a notebook computer, a terminal, a workstation, a server computer, a personal digital assistant (PDA) device, a tablet computer, a network device, a cellular phone, or other suitable computing device, processing device and/or communication device. Another embodiment of a computing system in accordance with some demonstrative embodiments of the invention, e.g., in the context of a wireless communication system, is described below with reference to FIG. 6.

As used herein, the term “interrupt request” (IRQ) may refer to a request for service by a processor; the term “interrupt source” may refer to any device that may generate an interrupt request (IRQ), for example, an input/output device. As used herein, the terms “assert” or “assertion” of an interrupt request may refer to a signal change to an active state, e.g., an IRQ signal or message from a source device to the interrupt controller, and/or from the interrupt controller to the processor. The term “report”, as used herein, may refer to the delivery of an interrupt request from the interrupt controller to the processor.

Although embodiments of the invention are not limited in this respect, interrupt controller 120 may be used in interrupt driven applications with multiple interrupt sources, as known in the art. For example, a non-limiting list of interrupt sources includes an embedded controller, a communication controller, a digital signal processor (DSP), a cellular controller, and/or a network processor. In some embodiments, an interrupt source may include a direct memory access (DMA) request, though it will be appreciated that in such cases, the time scale may be different from that of other sources.

In some embodiments, system 100 may include one or more processors 102. Processor 102 may include, for example, a central processing unit (CPU), a digital signal processor (DSP), a microprocessor, a host processor, a controller, a plurality of processors or controllers, a chip, a microchip, one or more circuits, circuitry, a logic unit, an integrated circuit (IC), an application-specific IC (ASIC), or any other suitable multi-purpose or specific processor or controller. Although embodiments of the invention are not limited in this respect, processor 102 may include or may be, by way of example only, a reduced instruction set computer (RISC), a processor that has a pipeline, a multi-core processor, a complex instruction set computer (CISC), and the like. In accordance with embodiments of the invention, processor 102 may include one or more processor cores, e.g., a processor core 101, including, for example, an execution block or subsystem, one or more execution units, a retirement unit, a decoder, a fetcher, an optional scheduler, one or more logic elements, switching elements, multiplexers, flip-flops, latches, transistors, circuits, sub-circuits, and/or other suitable components, as are known in the art.

In some embodiments, system 100 may include a shared bus, such as, for example, a “front side bus” (FSB) 104. FSB 104 may be, for example, a CPU data bus able to carry information between processor 102 and one or more other components of computing system 100. In some embodiments, FSB 104 may connect between processor 102 and a chipset, e.g., chipset 106. The chipset 106 may include one or more motherboard chips, e.g., a “northbridge” and a “southbridge”, and/or a firmware hub, and may optionally include connection points for additional buses and/or devices of computing system 100. In some embodiments, interrupt controller 120 may be integrated in the chipset 106, although embodiments of the invention are not limited in this regard.

In some embodiments, system 100 may include one or more peripheral device, e.g., peripheral devices 108 connected to chipset 106. For example, periphery 108 may include an input unit, e.g., a keyboard, a keypad, a mouse, a touch-pad, a joystick, a stylus, a microphone, or other suitable pointing device or input device; and/or an output unit, e.g., a cathode ray tube (CRT) monitor, a liquid crystal display (LCD) monitor, a plasma monitor, other suitable monitor or display unit, a speaker, or the like; and/or a storage unit, e.g., a hard disk drive, a floppy disk drive, a compact disk (CD) drive, a CD-recordable (CD-R) drive, a digital versatile disk (DVD) drive, or other suitable removable and/or fixed storage unit. Peripheral devices 108 may include input/output devices such as, for example, graphics controllers, video controllers, networking controllers, or other suitable components. The I/O devices and/or other devices included in peripheral devices 108 may generate interrupt requests, and may be referred to herein as interrupt sources.

In some embodiments, system 100 may include a memory unit 110, e.g., a system memory connected to chipset 106 via a memory bus. Memory unit 110 may include, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit a long term memory unit, or other suitable memory units or storage units. Computing system 100 may optionally include other suitable hardware components and/or software components.

In some embodiments, system 100 may include an interrupt request (IRQ) line 121, e.g., for communicating interrupt requests from peripheral devices or sources 108 to interrupt controller 120. For example, an IRQ may be sent as a signal or message via interrupt request line 121. In accordance with demonstrative embodiments of the invention, the scheduling interrupt controller 120 may arbitrate between multiple interrupt requests received via IRQ line 121, and report the requests to the processor for servicing the interrupt request, e.g., one at a time. For example, interrupt controller 120 may be able to prioritize and schedule interrupt requests according to dynamic system needs, taking into consideration one or more timing parameters of the requests, as described in detail below with reference to the remaining figures.

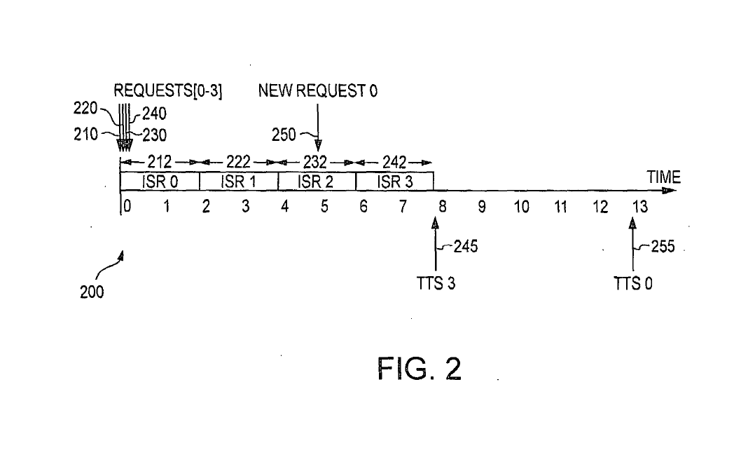

Reference is now made to FIG. 2, which schematically illustrates a timing diagram 200 helpful in understanding some features of a scheduling interrupt controller in accordance with some demonstrative embodiments of the invention. Although embodiments of the invention are not limited in this respect, the following timing parameters may be defined and/or used:
“TimeToFail”—Allowable timespan for completing processing of an interrupt request, measured from assertion of the interrupt request to the latest time that the interrupt service routine (ISR) may be activated without causing an error due to interrupt latency.
“TimeToService”—Allowable timespan for starting processing of an interrupt request, measured from assertion of the interrupt request from a peripheral device to the latest time that the ISR may perform an action on that device without causing an error due to interrupt latency.
“ISR_ProcessTime”—Time measured from activation of the ISR to the latest time that the ISR may perform action on a peripheral device without causing an error due to interrupt latency.

In some embodiments, the following equation, Equation 1, may be used to define the relationship between the timing parameters, although embodiments of the invention are not limited in this regard. In alternative embodiments, different equations may be used in accordance with different system and/or timing constraints.

TimeToService=ISR_ProcessTime+TimeToFail (1)

In conventional, non-scheduled, interrupt controllers, a high priority may be assigned to an interrupt request from a source that requires service within a short time of asserting the request, e.g., an interrupt source with a shorter TimeToService parameter value may be assigned a higher priority. However, such a priority scheme may not take into consideration the run-time status of the device requesting service. Thus, it is possible for an interrupt request to be assigned a low priority despite having a short TimeToFail parameter value, for example, due to time elapsed while waiting to be serviced.

For demonstrative purposes, timing diagram 200 schematically illustrates multiple interrupt requests, e.g., four requests 210, 220, 230, and 240, from sources having the same TimeToService and ISR_ProcessTime parameter values. For example, the requests 210-240 may be generated by devices of the same type, such as four synchronous serial protocol (SSP) controllers with substantially the same first-in-first-out (FIFO) threshold level and substantially the same rate.

Although embodiments of the invention are not limited in this respect, timing diagram 200 illustrates a worst case scenario where the multiple interrupt sources assert their respective interrupt requests 210-240 at substantially the same time, e.g., at time “0”. For purposes of the current example, assume that the ISR takes two time units to complete the SSP interrupt requests, e.g., that each of the requests 210-240 has an ISR_ProcessTime value of two. In such a case, the system may need to accommodate 2×4=8 time units of interrupt latency, and the SSP should be able to support a TimeToService value of eight time units. Accordingly, each of the SSP interrupt requests 210-240 asserted at time 0 may have a TimeToService value which expires at time “8”.

In the example of timing diagram 200, SSP interrupt requests 210-240 may all have the same priority relative to one another, and may therefore be scheduled for servicing in any order. In a static scheduling method, as used by conventional systems, subsequent requests from the four source SSPs may be scheduled in the same respective order. For example, as indicated in diagram 200, the ISR may initially be scheduled to service IRQ 210 in time span 212, IRQ 220 in time span 222, IRQ 230 in time span 232, and IRQ 240 in time span 242. Following completion of IRQ 210 at time “2”, the source SSP of IRQ 210 may generate a new request 250 at time “5”.

According to conventional static scheduling methods, the ISR may schedule the new IRQ 250 for service at time “6”, before the still-pending IRQ 240, since IRQ 250 may be associated with a “higher” priority interrupt source. It will be appreciated, however, that such scheduling, based on a static priority scheme, may result in error due to interrupt latency. For example, IRQ 240 may have a TimeToService value 245 which expires at time “8”, whereas the new IRQ 250 may have a TimeToService value 255 which expires later, at time “13”.

In contrast, a dynamic scheduling method in accordance with demonstrative embodiments of the invention may take into consideration the dynamics of the devices requesting service at run time, e.g., their respective TimeToFail parameter values, and prioritize and schedule the interrupt requests accordingly. For example, a scheduling interrupt controller may associate a TimeToFail parameter value with each interrupt source, and, when an interrupt request event is detected, schedule the new IRQ to be serviced no later than a “LatestServiceTime” sufficient for completion of the IRQ before causing a latency error at the interrupt source. For example, the following equation, Equation 2, may be used, although embodiments of the invention are not limited in this respect. Other implementations using other suitable scheduling algorithms are possible.

LatestServiceTime=CurrentTime+TimeToFail (2)

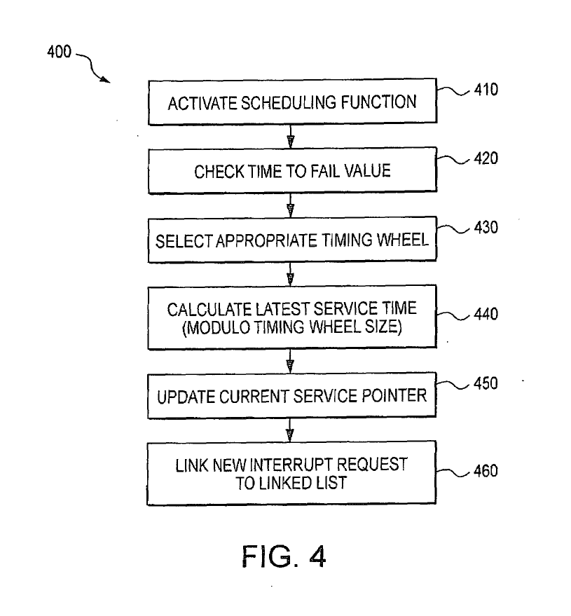

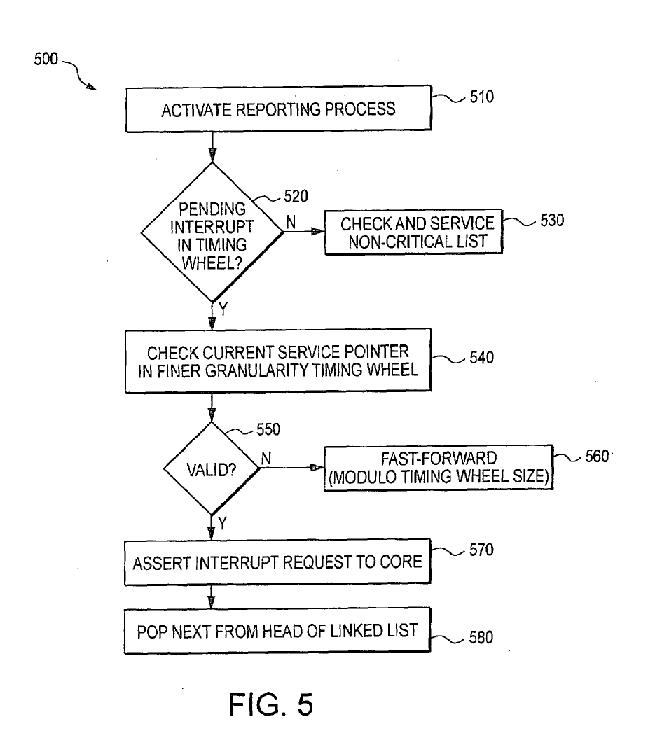

In some embodiments, the scheduling interrupt controller may provide a scheduling function, e.g., to decide the LatestServiceTime for an interrupt request, as well as a reporting function, e.g. for assertion of the interrupt request to the processor along with the selected interrupt ID. A scheduling function in accordance with one embodiment of the invention is described in detail below with reference to FIG. 4. A reporting function in accordance with one embodiment of the invention is described in detail below with reference to FIG. 5.

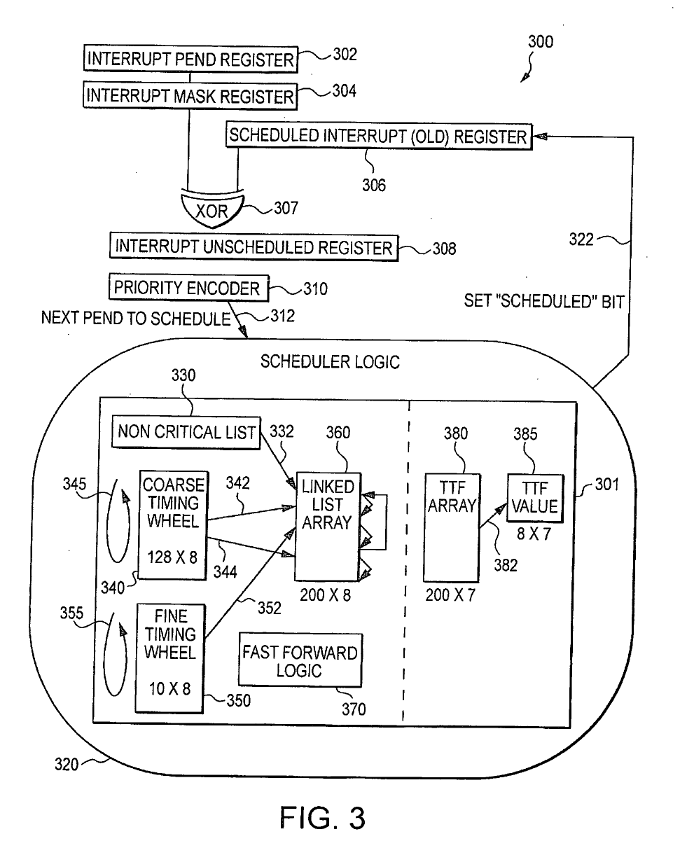

Reference is made to FIG. 3, which schematically illustrates bit and data structures of a scheduling interrupt controller 300 in accordance with one demonstrative embodiment of the invention. Although embodiments of the invention are not limited in this respect, the structures described in FIG. 3 may be included in an embodiment of interrupt controller 120 of FIG. 1, and/or of interrupt controller 642 or 644 of FIG. 6 (below).

According to some demonstrative embodiments of the invention, a new interrupt request may be initially stored in a pending interrupt register 302, e.g., an Interrupt Request Register (IRR), as known in the art. Interrupt controller 300 may include an interrupt mask register (IMR) 304, e.g., as known in the art, to optionally disable or cause to be ignored an interrupt request in pending register 302.

According to some demonstrative embodiments of the invention, interrupt controller 300 may include a scheduled interrupt register 306, e.g., to store scheduled interrupt requests. In addition, interrupt controller 300 may include an unscheduled interrupt register 308, e.g., to store asserted requests that have not yet been scheduled. For example, IC 300 may schedule one IRQ per clock, and additional interrupt requests asserted in the same clock cycle may be stored in the unscheduled register 308.

Although embodiments of the invention are not limited in this respect, entries in scheduled register 306 may include an indication bit to indicate whether a particular interrupt request has been scheduled. For example, as indicated by XOR operation 307, an interrupt request may be placed in unscheduled resister 308 if it is pending and not masked (registers 302 and 304), and not already scheduled (e.g., a “0” indication bit in register 306). After an IRQ is scheduled, the associated indication bit may be set to “scheduled” (e.g., a value of “1”), as indicated by arrow 322.

In some embodiments, interrupt controller 300 may include a priority encoder 310, e.g., to associate a relative priority scheme with the unscheduled interrupt requests. Any suitable priority scheme as known in the art may be used. For example, priority encoder 310 may be used to determine which pending IRQ in unscheduled register 308 may be sent next for scheduling. Interrupt controller 300 may include scheduler logic 320 to schedule a next pending interrupt request 312. Although embodiments of the invention are not limited in this respect, scheduler logic 320 may include one or more scheduling data structures 301, e.g., as shown.

In some embodiments, scheduling data structures 301 may include one or more hardware-controlled databases 392 and one or more user-controlled databases 393. Data structures 301, as described herein, may include or may be one embodiment of scheduler logic 320. However, other implementations are possible in accordance with different embodiments of the invention.

Hardware controlled databases 392 may include, for example, one or more cyclic buffers or timing wheels, as known in the art, e.g., coarse timing wheel 340 and fine timing wheel 350 to provide different granularity of events, an optional non-critical list 330, a combined linked list array structure 360, and fast forward logic 370.

User controlled databases 393 may include, for example, an array 380 of TimeToFail (TTF) values per interrupt parameters. Array 380 may be implemented using a RAM or any other suitable storage or memory device as is known in the art. In some embodiments, TTF array 380 may be optimized as follows: instead of storing a TTF value for each entry of input parameters in array 380, the entry may include a pointer 382 to a table 385 storing a limited set of TTF values, e.g., eight, TTF values in table 385.

In accordance with demonstrative embodiments of the invention, each interrupt source may be associated with a TimeToFail parameter value, e.g., based on a maximum interrupt latency tolerated by the interrupt source (e.g., the TimeToService parameter value) and a time required for processing of the interrupt request (e.g., the ISR_ProcessTime parameter value).

In accordance with demonstrative embodiments of the invention, interrupt controller 300 may schedule service of a plurality of interrupt requests, asserted by a plurality of respective interrupt sources, based on a timing parameter of the requests. For example, the interrupt controller may attempt to schedule the requests so that each request may be serviced no later than LatestServiceTime=CurrentTime+TimeToFail.

It will be appreciated that, in accordance with demonstrative embodiments of the invention, interrupt request events that arrive with different TimeToFail values may be scheduled at different times. For example, it is possible for a later interrupt request to be scheduled before previous interrupt requests if the TimeToFail value of the later request is shorter that that of the previous requests. Similarly, it is possible for an interrupt request with a longer TimeToFail value to be scheduled before one with a shorter TimeToFail value, e.g., if the longer TimeToFail request was triggered earlier.

In some embodiments, an interrupt request may not have an associated TimeToFail value; for example, the interrupt source may not require service within a defined time period (no TimeToService value). In such cases, the TimeToFail and/or TimeToService parameters may be set to a predefined value, e.g., an arbitrarily large number such as the largest integer value that can be represented within the computing system. Although embodiments of the invention are not limited in this respect, an interrupt request with no associated TimeToFail value may be stored in non-critical list 330 and may be serviced, for example, based on a “best effort” policy.

In some embodiments, if an interrupt request is not serviced before expiration of the LatestServiceTime, an error may be generated. Although embodiments of the invention are not limited in this respect, the expired interrupt request may be skipped and the next scheduled interrupt request may be serviced instead. Alternatively, in some embodiments the expired request may be serviced as scheduled, despite the error, for example, if the validity of scheduled interrupt requests is not checked.

Reference is also made to FIG. 4, which schematically illustrates a scheduling method 400 in accordance with some demonstrative embodiments of the invention. Although embodiments of the invention are not limited in this respect, method 400 may be performed by scheduler logic 320 of scheduling interrupt controller 300, e.g., using data structures 301.

As indicated at box 410, the scheduling function may be activated by a change in the pending interrupts register 302, e.g., by assertion of a new interrupt request. Although embodiments of the invention are not limited in this respect, activation of the scheduling function, e.g., scheduling logic 320, may involve one or more registers as described above with reference to FIG. 3.

As indicated at box 420, scheduling method 400 may include obtaining the appropriate TTF parameter value for a pending interrupt, e.g., by reading the entry from TTF array 380.

As indicated at box 430, method 400 may include selecting the appropriate timing wheel, e.g., coarse timing wheel 340 or fine timing wheel 350, for placement of the pending interrupt request. For example, the appropriate timing wheel may be selected based on the granularity of the TimeToFail parameter value. By way of example, a cellular controller source may generate interrupt requests, e.g., for multiplication of symbols, that require service within, for example, 66 microseconds, as well as more urgent interrupt requests that require service within, for example, 10 microseconds. Although embodiments of the invention are not limited by this example, in such a case, the coarse timing wheel 340 may be used to provide approximately 66 microsecond granularity, while fine timing wheel 350 may be used to provide approximately 10 microsecond granularity.

As indicated at box 440, method 400 may include calculating the LatestServiceTime for the pending IRQ, e.g., according to Equation 2 above. Although embodiments of the invention are not limited in this respect, LatestServiceTime may be calculated modulo the selected timing wheel size, e.g., to determine appropriate location for placement within the timing wheel.

As indicated at box 450, method 400 may include adjusting the current service pointer to point at the location of the earliest LatestServiceTime, for example, using the following pseudocode:

(Code 1)

IF LatestServiceTime < CurrentServicePointer THEN
CurrentServicePointer <= LatestServiceTime

In some embodiments, timing wheels 340 and 350 may be associated with service pointers 345 and 355, respectively. Pointers 345 and 355 may be used, for example, to point at a location within the respective timing wheels of a next IRQ to be reported and/or scheduled, e.g., in the linked list array. A more detailed description of the reporting process for one timing wheel is described below with reference to FIG. 5.

As indicated at block 460, method 400 may include linking the new interrupt request from the timing wheel to a linked list pointed at by a pointer, e.g., pointer 342, 344, or 352, in the timing wheel location corresponding to “LatestSeiviceTime”. The linked list may be maintained, for example, in the linked list array 360, which may combine interrupt requests from the one or more timing wheels and non critical list. Although embodiments of the invention are not limited in this respect, the following procedure, for example, may be used:

(Code 2)

Read “previous head pointer” from TimingWheel [LatestServiceTime].
Write “previous head pointer” to LinkedListArray [NewInterruptID]
Write NewInterruptID to TimingWheel [LatestServiceTime]

Reference is made to FIG. 5, which schematically illustrates a method 500 of reporting interrupt requests in accordance with some demonstrative embodiments of the invention.

As indicated at box 510, the reporting method may be activated by acknowledgment of a new interrupt request by a processor core, e.g., processor core 101 in the embodiment of FIG. 1, and/or processor cores 622 and 624 in the embodiment of FIG. 6 (below). Reporting method 500 may be performed for each timing wheel in the interrupt controller, e.g., timing wheels 340 and 350 (FIG. 3).

As indicated at box 520, method 500 may include checking whether there is a pending IRQ in at least one timing wheel. As indicated at box 530, if there are no pending interrupt requests in the timing wheels, the non-critical list of interrupt requests, e.g., list 330 (FIG. 3) may be checked. Method 500 may include servicing of non critical interrupt requests, e.g., requests which do not have an associated TTF parameter value, or for which the TTF value is set to be arbitrarily large, when there are no other pending interrupt requests.

As indicated at box 540, if an interrupt request is pending at the CurrentServicePointer location in two wheels, then the one in the finer granularity timing wheel takes precedence. For example, a pending IRQ in fine timing wheel 350 may be reported before a pending IRQ in coarse timing wheel 340, although embodiments of the invention are not limited in this regard.

As indicated at boxes 550 and 560, method 500 may include advancing the current service pointer to skip over empty or non-valid timing wheel entries, for example, by using “fast forward” logic 370. Invalid entries may include, for example, an interrupt request for which the LatestServiceTime value is expired. Although embodiments of the invention are not limited in this respect, the following procedure may be used:

(Code 3)

IF TimingWheel[CurrentServicePointer].not_valid THEN
CurrentServicePointer ++ (modulo timing wheel size)

As indicated at box 570, reporting method 500 may include assigning an interrupt ID to a timing wheel entry for reporting to the processor core. Although embodiments of the invention are not limited in this respect, the following procedure may be used:

(Code 4)

ELSE assert interrupt request to core with interrupt ID =
TimingWheel[CurrentServicePointer].Interrupt ID

As indicated at box 580, reporting method 500 may include popping the head of the list in the linked list array, e.g., to advance the current service pointer to the next scheduled interrupt request. Although embodiments of the invention are not limited in this respect, the following procedure may be used:

(Code 5)

TimingWheel[CurrentServicePointer].Interrupt ID <=
LinkedListArray[TimingWheel[CurrentServicePointer].Interrupt ID].next

Reference is made to FIG. 6, which schematically illustrates a wireless communication system 600 including a scheduling interrupt controller in accordance with some demonstrative embodiments of the invention. Although the scope of the present invention is not limited to this example, wireless communication system 600 may include at least one base station 601 and at least one mobile unit 605, and one or more wireless communication links 603, e.g., an uplink and a downlink, to transfer communications between the base station and mobile unit.

In some embodiments, base station 601 and mobile unit 605 may each include one or more antennas 602 and 604, respectively, to transmit and receive wireless communication signals. For example, antennas 602 and 604 may be operatively coupled to a transmitter and/or receiver in base station 601 and mobile unit 602, respectively, which may be implemented as a transceiver, a transmitter-receiver, a wireless modem, or one or more units able to perform separate or integrated functions of sending and/or receiving wireless communication signals, blocks, frames, data items, transmission streams, packets, messages, and/or data. In some embodiments, wireless communication link 603 may include one or more sub-channels, which may be used for voice and/or data transportation. Furthermore, the sub-channels may include a plurality of sub-carriers to carry signals, for example, pilot signals, coded signals, data signals, control signals, or the like. In some embodiments, the wireless communication signals sent and/or received via antennas 602 and 604, when processed, may result in generation of one or more interrupt requests.

Although embodiments of the invention are not limited in this respect, mobile unit 605 may include a computing system 610 in which a scheduling interrupt controller may be used. Computing system 610 may be, for example, an embedded system such as, e.g., a cellular processor, including a RTOS. Computing system 610 may include multiple processors and/or cores, e.g., processors 612 and 614 having cores 622 and 624, respectively, a plurality of interrupt sources, e.g., peripherals 620, and may operate under real-time constraints including, e.g., interrupt latency tolerances.

In some embodiments, processor 612 may be a data processor such as, for example, processor 102 of FIG. 1. Processor 612 may include a core 622, a memory 632, and an interrupt controller 642, e.g., a scheduling interrupt controller in accordance with demonstrative embodiments of the invention. Memory 632 may include, for example, an instruction cache, a data cache, a Flash memory, a SRAM, and/or the like. In addition, processor memory 632 may be operatively associated with, e.g., a memory controller 631 and an external memory bus 635. One or more interrupt sources, e.g., peripherals 620, may be coupled to processor 612 via a bus bridge 621 and an interface 646.

Although embodiments of the invention are not limited in this respect, interrupt controller 642 may be a scheduling interrupt controller such as, for example, interrupt controller 120 (FIG. 1) or interrupt controller 300 (FIG. 3). In some embodiments, interrupt controller 642 may be operatively associated with an IRQ controller 641, which may, for example, interface between the interrupt controller 642 and new interrupt requests asserted by the peripherals 620. In some embodiments, IRQ controller 641 may be integrated with interrupt controller 642.

In some embodiments, computing system 610 may include a second processor 614, e.g., a baseband signal processor or other special-purpose processor as known in the art. Processor 614 may be coupled to processor 612 via an interface 616, e.g., a point-to-point interface. Although embodiments of the invention are not limited in this respect, processor 614 may include, for example, a core 624, a memory 634, and a controller 644, e.g., a memory controller, a DMA controller, or an interrupt controller. For example, controller 644 may arbitrate between a plurality of interrupt and/or memory access requests to core 624 and memory 634, respectively, and may operate as described above with reference to FIGS. 2-5. Interrupt sources may include, for example, one or more sub-modules of processor 614 such as, for example, a RF controller, a cipher accelerator, a Viterbi decoder accelerator, and the like.

In some embodiments of the invention, computing system 610 may include a one or more clock and power components 618, e.g., to provide timing signals to processors 612 and 614. Clock and power components 618 may include, by way of example, a phase-locked loop (PLL) or other suitable timing components, a chip-level power management module, and a power ON control.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

Some embodiments of the invention may be implemented, for example, using a machine-readable medium or article which may store an instruction or a set of instructions that, if executed by a machine, for example, by system 100 of FIG. 1, by device 605 of FIG. 6, by processor 102 of FIG. 1, by processor 612 and/or 614 of FIG. 6, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 110, 632, 634), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A method comprising:
scheduling a plurality of interrupt requests from a plurality of interrupt sources having respective interrupt latency tolerances, based on one or more timing parameters, wherein at least one of said timing parameters is responsive to an allowable timespan for processing of said interrupt requests.

2. The method of claim 1, wherein at least one of said timing parameters is responsive to a time said interrupt requests are received from the respective sources.

3. The method of claim 1, comprising sorting said plurality of interrupt requests for scheduling according to a timing granularity based on the interrupt latency tolerances of the respective sources.

4. The method of claim 1, comprising calculating a latest-service-time parameter corresponding to a sum of the time an interrupt request is received and the allowable timespan for processing of the interrupt request.

5. The method of claim 1, wherein scheduling comprises scheduling a request for service no later than a latest-service-time, which corresponds to a sum of the time an interrupt request is received and the allowable timespan for processing of the interrupt request.

6. The method of claim 4, wherein the plurality of interrupt requests are associated with relative priorities based on the interrupt latency tolerances of the respective sources, and wherein scheduling comprises scheduling for service a lower priority request before a higher priority request if the lower priority request has a shorter latest-service-time parameter.

7. The method of claim 5, comprising skipping over an interrupt request if the latest-service-time value associated with said request is expired.

8. An apparatus comprising:
a processor having an interrupt controller to schedule service of a plurality of interrupt requests from a plurality of respective sources, the sources having respective interrupt latency tolerances, based on one or more timing parameters, wherein at least one of said timing parameters is responsive to an allowable timespan for processing of said interrupt requests.

9. The apparatus of claim 8, wherein at least one of said timing parameters is responsive to a time said interrupt requests are received from the respective sources.

10. The apparatus of claim 8, wherein the interrupt controller comprises one or more data structures to store said plurality of interrupt requests for scheduling according to a timing granularity based on the interrupt latency tolerances of the respective sources.

11. The apparatus of claim 8, wherein the interrupt controller is to schedule a request for service no later than a latest-service-time, which corresponds to a sum of the time an interrupt request is received and the allowable timespan for processing of the interrupt request.

12. The apparatus of claim 11, wherein the plurality of interrupt requests are associated with relative priorities based on the interrupt latency tolerances of the respective sources, and wherein the interrupt controller is to schedule for service a lower priority request before a higher priority request if the lower priority request has a shorter latest-service-time parameter value.

13. The apparatus of claim 11, wherein the interrupt controller is to skip over an interrupt request if the latest-service-time value associated with said request is expired.

14. The apparatus of claim 8, comprising a memory coupled to said processor, to store one or more instructions executable by said processor for scheduling of said interrupt requests.

15. A system comprising:
at least one wireless communication device comprising:
a processor having an interrupt controller to schedule service of a plurality of interrupt requests from a plurality of respective sources, the sources having respective interrupt latency tolerances, based on one or more timing parameters, wherein at least one of said timing parameters is responsive to an allowable timespan for processing of said interrupt requests; and
an antenna, coupled to said wireless communication device, to send and receive wireless communication signals which, when processed, result in generation of one or more of said plurality of interrupt requests.

16. The system of claim 15, comprising an additional wireless communication device to send said wireless communication signals received by said antenna.

17. The system of claim 15, wherein at least one of said timing parameters is responsive to a time said interrupt requests are received from the respective sources.

18. The system of claim 15, wherein the interrupt controller comprises one or more data structures to store said plurality of interrupt requests for scheduling according to a timing granularity based on the interrupt latency tolerances of the respective sources.

19. The system of claim 15, wherein the interrupt controller is to schedule a request for service no later than a latest-service-time, which corresponds to a sum of the time an interrupt request is received and the allowable timespan for processing of the interrupt request.

20. The system of claim 19, wherein the plurality of interrupt requests are associated with relative priorities based on the interrupt latency tolerances of the respective sources, and wherein the interrupt controller is to schedule for service a lower priority request before a higher priority request if the lower priority request has a shorter latest-service-time parameter value.

21. The system of claim 19, wherein the interrupt controller is to skip over an interrupt request if the latest-service-time value associated with said request is expired.
